(19) United States
(12) Patent Application Publication
(10) Pub. No.: US 2005/0289584 A1
(43) Pub. Date: Dec. 29, 2005

(54) Method for locking and unlocking functionality of television data receiver and arrangement therefor

(76) Inventors: Tomasz Kozlowski, Zielona Gora (PL); Adam Pawlowski, Lodz (PL)

Correspondence Address: WILLIAM COLLARD;COLLARD & ROE, P.C., 1077 NORTHERN BOULEVARD, ROSLYN, NY, 11576, US

(21) Appl. No.: 11/158,468

(22) Filed: Jun. 22, 2005

(30) Foreign Application Priority Data
Jun. 24, 2004 (PL) 368770

(51) Int. Cl. H04N 7/16; H04N 7/167

(52) U.S. Cl. 725/25; 725/31

(57) ABSTRACT

A method for locking and unlocking a functionality of a television data receiver, in which executing the functionality locking function involves interrupting the display of an active channel, displaying a substitute signal, storing a current configuration of the receiver in a memory and configuring the receiver to a transitional state. Executing the functionality unlocking function involves performing authorization and upon successful authorization, reading the configuration of the receiver from the memory and configuring the receiver in accordance with the read configuration. The configuration may further include settings of applications active upon activating a functionality locking function.

### CROSS-REFERENCE TO RELATED APPLICATIONS

This application claims priority to Polish Patent Application No. P-368770, filed on 24 Jun. 2004, the contents of which are incorporated herein by reference.

### BACKGROUND OF THE INVENTION

1. Field of the Invention

The object of the invention is a method for locking and unlocking a functionality of a television data receiver and an arrangement for locking and unlocking a functionality of a television data receiver. The television data receiver can be a TV set, a digital television decoder or a personal computer with a screen.

2. Brief Description of the Background of the Invention Including Prior Art

One of the best-known concepts for locking and unlocking the functionality of a device with a screen is a so-called “screen saver”, widely used with personal computers. A typical screen saver is activated after certain period of user inactivity or by calling a dedicated command. After the screen saver is activated, the display screen is turned blank or a predefined image is presented thereon, while the access to the computer functionality is locked. The screen saver is deactivated (and the computer functionality is unlocked) usually by a resume of user activity (for example, the press of a key on a keyboard or the movement of a mouse). Screen saver deactivation may also require entering a password, so that unauthorized users may not gain access to computer functionality.

The PCT application No. WO02/17626 entitled “Television set having additional functions” presents a television data receiver with a functionality similar to the screen saver for a personal computer as described above. The functionality is similar in that after the user turns off the receiver, various images are presented on the display, thus serving a decorative function.

The US patent application No. U.S. 2002/0029382 entitled “Method of locking or unlocking a service on a digital receiver of audiovisual programs and device for implementing the method” presents a method for locking television channels. If a manual action is performed by the user while watching a channel, that channel is added to a list of locked channels, which enables the user to manually lock a set of channels.

The U.S. Pat. No. 5,537,612 entitled “Remotely selectable audio/video/text disruption” presents a method for disrupting the display of an audio-visual display device, which is activated by transmitting a series of codes from a remote control unit to the device. The display may be disrupted by displaying a solid color or setting the contrast and brightness levels of the display to less than optimal settings.

As seen from the above examples, there are some known methods for locking or disturbing the display of a device, especially a television data receiver. However, they do not provide an unlocking mechanism that would restore the configuration of the receiver prior to its locking. Moreover, the known methods are not user-dependent, i.e. the locking of the device by one user disables the device for all other users. Furthermore, the known solutions are not integrated with a signal recording system, and do not provide signal recording while the device is locked.

### SUMMARY OF THE INVENTION

Purposes of the Invention

It is an object of the present invention to provide a method and an arrangement for locking and unlocking a functionality of a television data receiver, which would enable, at unlocking, restoring the configuration of the receiver prior to its locking. Furthermore, the invention provides means for management of locking for various users and for recording the contents of the channel which was locked and displaying the locked content after unlocking.

This and other objects and advantages of the present invention will become apparent from the detailed description, which follows.

Brief Description of the Invention

The object of the invention is a method for locking and unlocking a functionality of a television data receiver, in which executing the functionality locking function involves interrupting the display of an active channel, displaying a substitute signal, storing a current configuration of the receiver in a memory, the configuration including an identifier of the last active channel and configuring the receiver to a transitional state, and executing the functionality unlocking function involves performing authorization and upon successful authorization, reading the configuration of the receiver from the memory and configuring the receiver in accordance with the read configuration. The configuration may further include settings of applications active upon activating a functionality locking function.

Preferably, while executing the functionality locking function, the recording of the signal of the last active channel in a buffer is initiated, and a reference to the recording in the buffer is included in the configuration. The recording can be continued for a predefined time, or until the end of the program on the last active channel, or until the buffer is full. Moreover, while configuring the receiver in accordance with the read configuration, depending on a selection made by a user, the current signal of the last active channel is displayed or the recorded signal of the last active channel is displayed.

Preferably, the configuration is stored separately for each user profile and the receiver is configured separately for each user profile. The functionality unlocking function can be activated by activating a user profile for which the receiver was configured to a transitional state. The substitute signal may be the default channel of the main profile.

The substitute signal can be a user profile selection screen, the television channel assigned as the first channel, or a blank screen.

The transitional state can be a stand-by state. The functionality locking function can be activated by turning off the receiver.

The object of the invention is also an arrangement for locking and unlocking a functionality of a television data receiver, comprising a memory and a functionality locking controller for executing functionality locking and unlocking functions as described above.

### BRIEF DESCRIPTION OF THE DRAWINGS

In the accompanying drawings one of the possible embodiments of the present invention is shown, where:

FIG. 1 presents a digital television decoder with an arrangement according to the invention;

FIG. 2 presents general procedures for locking and unlocking the functionality of a television data receiver;

FIG. 3 presents a detailed procedure for locking the functionality of a television data receiver provided with a television signal recording system; and

FIG. 4 presents a detailed procedure for unlocking the functionality of a television data receiver provided with a television signal recording system.

### DESCRIPTION OF INVENTION AND PREFERRED EMBODIMENT

In the presented embodiments, a digital television decoder (also known as a set-top box) was presented as an example of a television data receiver. However, the presented invention can be also employed with other types of television data receivers, for example standard TV sets or computers, optionally equipped with a signal recording system.

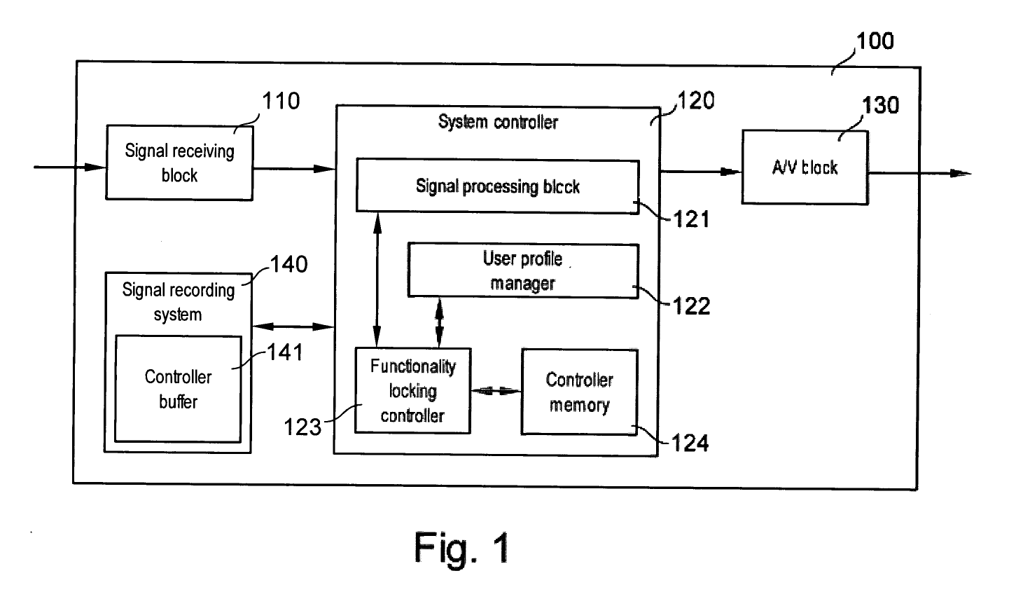

FIG. 1 presents a simplified structure of a digital television decoder as an example of a television data receiver. For clarity purposes, it presents only the functional blocks, which are most important for implementing the presented embodiment.

A digital television decoder, being an exemplary embodiment of a television data receiver 100, comprises a signal receiving block 110, which receives digital television signal, a system controller 120, which controls signal processing procedures and operation of the whole system and an audio/video block 130, which converts the signal into a form acceptable by a television receiver connected to the decoder. The system controller 120 comprises a signal processing block 121, which is responsible for signal processing, involving for example signal decoding and descrambling.

The system controller 120 comprises a functionality locking controller 123. The controller 123 is responsible for executing the locking and unlocking procedures. The controller 123 is linked with a controller memory 124 for storing the current configuration of the television data receiver. The configuration includes at least an identifier of a television channel active at the moment of calling the locking function. The configuration stored in the controller memory 124 allows resuming the functionality of the television data receiver 100 after its functionality is unlocked.

In addition, the system controller 120 may contain a user profile manager 122, which allows configuring the functionality of the decoder for each user separately.

The digital television decoder 100 can be also equipped with a television signal recording system 140, also known as a Digital Video Recorder (DVR). The signal recording system 140 contains a controller buffer 141, for example a hard disk drive, for recording the signal of the locked television channel. If the television data receiver 100 is equipped with the user profile manager 122, the signal recording system 140 can have a number of controller buffers 141, a separate buffer being assigned for each user.

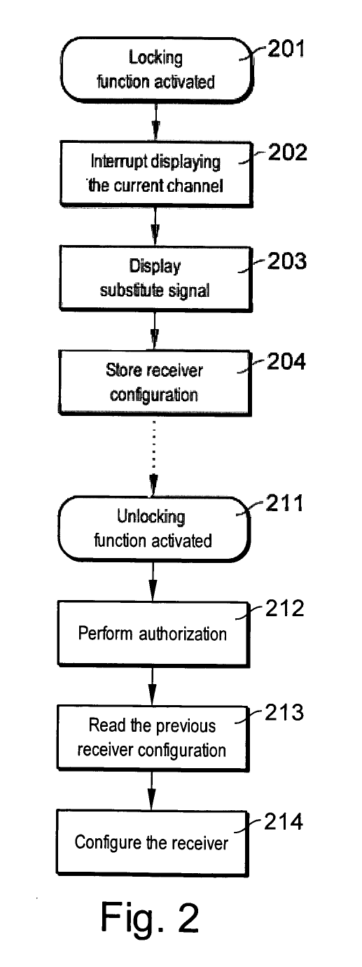

FIG. 2 presents general procedures for locking and unlocking the functionality of the television data receiver. The functionality locking function is activated in step 201 by the user, for example, by pressing a dedicated button of a remote control, or by turning off the digital television decoder. In case of turning off the digital television decoder, a substitute signal is not displayed, therefore the step 203 is skipped. The display of the signal of the active television channel is stopped in step 202, which allows to quickly hide the activities of the user from unauthorized public. Next, in step 203, a substitute signal is displayed. The substitute signal can be a blank screen, which emulates the receiver in a turned-off state. Alternatively, the substitute signal can be a signal of another television channel, for example a channel with number 1, or a channel most frequently watched. Furthermore, instead of displaying the substitute signal, the receiver can be switched to a stand-by state. In step 204, the current configuration of the television data receiver is stored in the controller memory. In the simplest embodiment, the configuration data can include an identifier of the last active television channel (i.e. a television channel active at the moment of activating the functionality locking function).

The functionality unlocking function can be activated in step 211 by means of a dedicated button of the remote control or the button used for functionality locking function activation. The functionality unlocking function can be also activated by switching to the channel, which was active earlier (i.e. at the time the locking function was activated). After unlocking function activation, an authorization is made in step 212 in order to check if a given user has rights to unlock functionality of the receiver, for example, by entering an access code. In case of a failed authorization of the unlocking function, the receiver is returned to the state from before calling the unlocking function. In case of a successful authorization, the previous configuration of the receiver is read from the controller memory in step 213 and the functionality of the receiver is configured accordingly in step 214. The configuration may, for example, specify a return to a previously displayed channel.

After the activation of the functionality locking function and until the activation of the functionality unlocking function, the television data receiver operates in a transitional state, which may enable, for example, the following functionality (according to the configuration of the system):
full functionality (i.e. all channels active)—which prevents other users from realizing that the functionality of the receiver was locked earlier;
limited functionality—all channels are active besides the channel active at the moment of calling the locking function; or
all the functions are locked.

If the television data receiver, besides displaying of television channels, allows handling various applications (such as, for example, games, business applications, e-mail, program guides etc.), the current settings of these applications are additionally included when recording the configuration of the receiver in the controller memory. It makes it possible to resume the operation of those applications after unlocking the functionality of the receiver.

If the television data receiver is additionally equipped with a user profile manager, the functionality is locked and the current configuration is recorded for each user independently from other users. In such a case, the locking of the receiver functionality can be equal to locking the profile of a given user. Then, the screen of the user profile selection can be displayed as a substitute signal. In another embodiment, the receiver is switched automatically to the main profile and the default channel for the given profile is selected (for example, the first channel from the list of the most often used channels). Unlocking the functionality of the receiver for a given profile is made by activating a profile that was locked earlier.

If the television data receiver is equipped with the television signal recording system, then after activation of the functionality locking function, the recording of the signal that was active is additionally started. It allows the user to return to watching the program that was stopped.

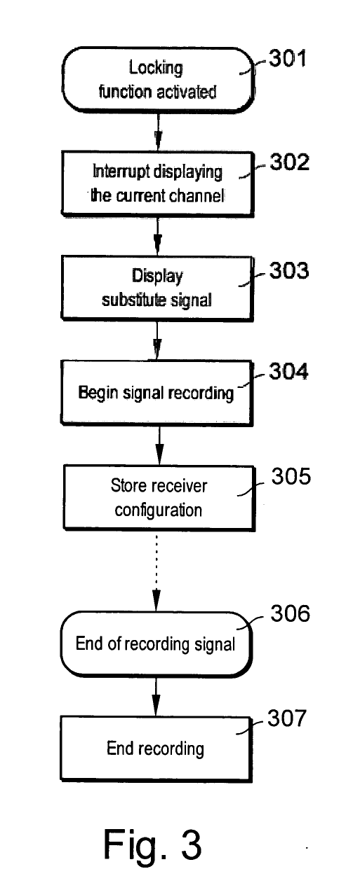

FIG. 3 presents a procedure for locking the functionality of the television data receiver, equipped with the television signal recording system. The successive steps 301-303 of this procedure are similar to the corresponding successive steps 201-203 shown in FIG. 2. Additionally, in step 304, the recording of the signal of the earlier active television channel is started and the signal is further recorded in the controller buffer. Next, in step 305, the configuration of the receiver that contains both the identifier of the earlier active channel and reference to the signal recording buffer is stored. Signal recording in the buffer is continued until the moment of appearance of the recording end signal in the step 306. Such signal can appear as a result of shortage of space in the buffer or the end of an earlier active program, depending on how the system was configured by the user. After the recording end signal appears in step 307, the recording of the signal in the buffer is stopped.

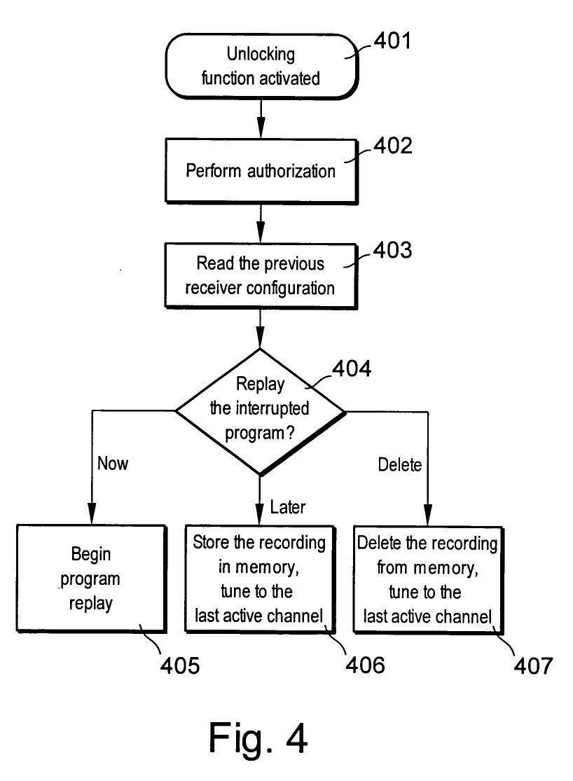

FIG. 4 presents a procedure for unlocking the functionality of the television data receiver, equipped with the television signal recording system. The successive steps 401-403 of this procedure are similar to the corresponding successive steps 211-213 shown in FIG. 2. After reading the previous configuration of the receiver from the controller memory, the user decides in step 404 whether to watch the program that was interrupted, or to watch the current content of the previously active television channel. In case of selecting the option “Now”, in step 405, the display of the program recorded in the buffer is started. In case of selecting the option “Later”, the recorded program is left in the memory of the signal recording system (with a possibility of moving it to another buffer of the signal recording system). In case of selecting the option “Delete”, the recording is removed from the buffer, and next the receiver is set to the previously active channel.

While the preferred embodiments of the present invention have been illustrated and described, it will be understood by those skilled in the art that various changes and modifications may be made, and equivalents may be substituted for elements thereof. Such variations are not regarded as a departure from the invention, the true scope of the invention being set forth in the claims appended hereto.

1. A method for locking and unlocking a functionality of a television data receiver, comprising the steps of:
activating a functionality locking function;
executing the functionality locking function, including interrupting the display of an active channel, displaying a substitute signal, storing a current configuration of the receiver in a memory, the configuration including an identifier of the last active channel and configuring the receiver to a transitional state;
activating a functionality unlocking function; and
executing the functionality unlocking function, including performing authorization and upon successful authorization, reading the configuration of the receiver from the memory and configuring the receiver in accordance with the read configuration.

2. The method according to claim 1, further including the steps of
while executing the functionality locking function, initiating recording of the signal of the last active channel in a buffer, and including in the configuration a reference to the recording in the buffer.

3. The method according to claim 2, wherein the recording is continued for a predefined time.

4. The method according to claim 2, wherein the recording is continued until the end of the program on the last active channel.

5. The method according to claim 2, wherein the recording is continued until until the buffer is full.

6. The method according to claim 2, wherein while configuring the receiver in accordance with the read configuration, depending on a selection made by a user, the current signal of the last active channel is displayed or the recorded signal of the last active channel is displayed.

7. The method according to claim 1, wherein the configuration further includes settings of applications active upon activating a functionality locking function.

8. The method according to claim 1, wherein the configuration is stored separately for each user profile and the receiver is configured separately for each user profile.

9. The method according to claim 8, wherein the functionality unlocking function is activated by activating a user profile for which the receiver was configured to a transitional state.

10. The method according to claim 8, wherein the substitute signal is the default channel of the main profile.

11. The method according to claim 8, wherein the substitute signal is a user profile selection screen.

12. The method according to claim 1, wherein the substitute signal is the television channel assigned as the first channel.

13. The method according to claim 1, wherein the substitute signal is a blank screen.

14. The method according to claim 1, wherein the transitional state is a stand-by state.

15. The method according to claim 1, wherein the functionality locking function is activated by turning off the receiver.

16. An arrangement for locking and unlocking a functionality of a television data receiver, the arrangement comprising
a controller memory (124) for storing a configuration of the receiver (100), including an identifier of the last active channel; and
a functionality locking controller (123) for executing functionality locking function, including interrupting the display of an active channel, displaying a substitute signal and storing a current configuration of the receiver (100) in the memory (124) and for executing functionality unlocking function, including reading the configuration of the receiver (100) from the memory (124) and configuring the receiver (100) in accordance with the read configuration.

17. The arrangement according to claim 16, comprising additionally a signal recording system (140) with a controller buffer (141) for recording the television signal, wherein executing the functionality locking function additionally includes initiating recording of the signal of the last active channel in the buffer (141) and the configuration of the receiver stored in the controller memory (124) additionally includes a reference to the recording in the controller buffer (141).
